(19) United States
(12) Patent Application Publication
(10) Pub. No.: US 2019/0202364 A1
(43) Pub. Date: Jul. 4, 2019

(54) DOG ASSISTANCE STEP

(71) Applicant: Thomas Bostwick, Luxemburg, WI (US)

(72) Inventor: Thomas Bostwick, Luxemburg, WI (US)

(21) Appl. No.: 16/145,000

(22) Filed: Sep. 27, 2018

Related U.S. Application Data
(60) Provisional application No. 62/612,996, filed on Jan. 2, 2018.

(51) Int. Cl. B60R 3/00; A01K 1/035

(52) U.S. Cl. CPC B60R 3/007; A01K 1/035

(57) ABSTRACT

A staircase for installation onto a vehicle is disclosed herein. The staircase includes an attachment-mechanism, a first-step and a second-step. The first-step and the second-step are pivotally connected such that the staircase is able to move between a folded-position and an unfolded-position. The staircase offers an effective method for loading elderly or disabled dogs into vehicles without strain on the pet owner and prevents the pets from scratching the paint of a vehicle as they enter or exit.

### CROSS REFERENCE TO RELATED APPLICATION

The present application is related to and claims priority to U.S. Provisional Patent Application No. 62/612,996 filed Jan. 2, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of stairs and more specifically relates to a foldable and portable staircase for pets.

### 2. Description of Related Art

When an animal owner is required to transport a domestic animal in a vehicle, assistance is sometimes required to get the animal into the vehicle. For example, some dogs or cats are too large to be lifted and placed in a vehicle, or the structure of the vehicle can make it difficult for the animal to climb into the vehicle. As such, pet owners often have difficulty loading and unloading their pets from a vehicle. It can be especially hard to get disabled or elderly animals in and out. Lifting a heavy dog can put unnecessary strain on the individual. Pets may become frightened or panicked and can scratch the vehicle in the process. They may also fall and injure themselves when attempting to get in or out. A suitable solution is desired.

U.S. Pub. No. 2009/0188444 to Robert F. Whalen relates to a folding pet staircase. The described folding pet staircase includes a plurality of stair treads operatively connected by articulating links in such a manner that the treads can be pivoted in unison from a stowed position of the staircase, in which the treads are substantially stacked upon one another, to a plurality of extended positions, in which the links position the treads in a spaced and parallel relationship to one another. A latch selectively secures the staircase in a selected one of the extended positions. The latch is configured for preventing further pivoting of the treads in either direction between the stowed and extended positions of the staircase, when the latch is engaged.

### BRIEF SUMMARY OF THE INVENTION

In view of the foregoing disadvantages inherent in the known stairs art, the present disclosure provides a novel dog assistance step. The general purpose of the present disclosure, which will be described subsequently in greater detail, is to provide a hitch-mounted set of steps designed to assist in loading dogs of all ages into the back of vehicles, offering an effective method for loading elderly or disabled dogs into vehicles without strain on the pet owner whilst preventing the pet from scratching the paint of a vehicle as they enter or exit. This ensures pets of all sizes are able to enter and exit a vehicle with ease.

A staircase is disclosed herein. The staircase includes an attachment-mechanism configured to mount the staircase to a rear-surface of a vehicle. A first-step may be attached to the attachment-mechanism and may include a first L-shaped configuration defined by a first stepping-section and a first wall-section. Similarly, a second-step may be provided and may include a second L-shaped configuration defined by a second stepping-section and a second wall-section. The second wall-section may be pivotally-connected to the first stepping-section such that the second-step may be configured to pivot between a folded-state and an unfolded-state.

A method of using the staircase is also disclosed herein. The method of using the staircase may comprise the steps of providing the staircase, as above; installing the staircase onto the rear-surface of the vehicle via the attachment-mechanism; pivoting the second-step into the unfolded-state; using the staircase to enter the rear of the vehicle; and pivoting the second-step into the folded-state.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a dog assistance step, constructed and operative according to the teachings of the present disclosure.

FIG. 1 is a front perspective view of the staircase during an ‘in-use’ condition, according to an embodiment of the disclosure.

FIG. 2A is a side perspective view of the staircase of FIG. 1, according to an embodiment of the present disclosure.

FIG. 2B is a front perspective view of the staircase of FIG. 1, according to an embodiment of the present disclosure.

FIG. 3A is a bottom perspective view of the staircase of FIG. 1, according to an embodiment of the present disclosure.

FIG. 3B is a bottom perspective view of the staircase of FIG. 1, according to an embodiment of the present disclosure.

FIG. 4 is a flow diagram illustrating a method of use for staircase, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to stairs and more particularly to dog assistance steps as used to improve the foldable, portable staircase for pets.

Generally disclosed is a set of steps for attachment to a back of a vehicle. The set of steps may be folded into a box-configuration that may be attached to the back of the vehicle. When needed, the set of steps may be unfolded from the box-configuration. The set of steps may be configured to stay on the vehicle, or alternatively, the steps may be removed from the vehicle. The set of steps may flip up to the back of the vehicle when not in use and unfold when needed. The steps may be constructed from rust-free aluminum, stainless steel, and includes a non-slip surface. The unit may also be made from plastic. The exact specifications may vary.

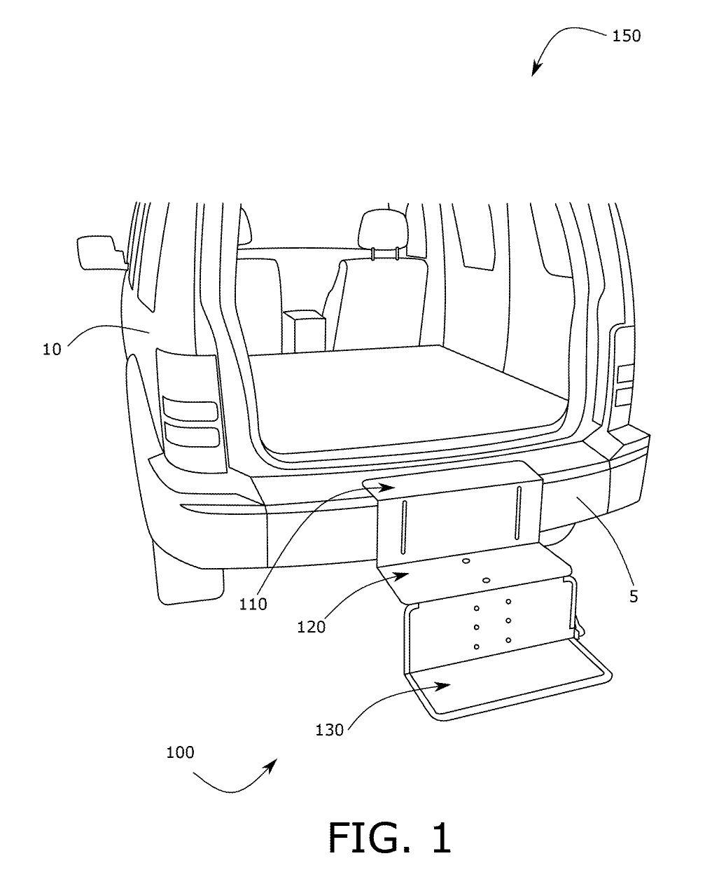

Referring now more specifically to the drawings by numerals of reference, there is shown in FIGS. 1-5, various views of a staircase 100.

FIG. 1 shows a staircase 100 during an ‘in-use’ condition 150, according to an embodiment of the present disclosure. As Illustrated, the staircase 100 may include an attachment-mechanism 110; a first-step 120 and a second-step 130. As shown, the staircase 100 may be used for installation onto a vehicle 10. Further, the attachment-mechanism 110 may be configured to mount the staircase 100 to a rear-surface 5 of the vehicle 10. In one embodiment, the staircase 100 may be constructed of aluminum. In another embodiment, the staircase 100 may be constructed of stainless steel. However, it should be appreciated that other materials are contemplated. While this embodiment depicts a staircase with two stairs or steps, other embodiments exist with more than two steps. Also, embodiments exist that have only one step.

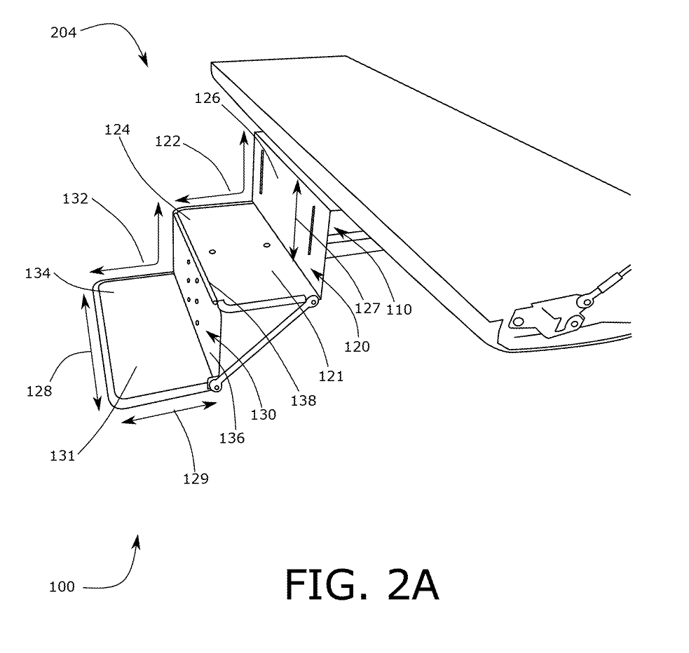

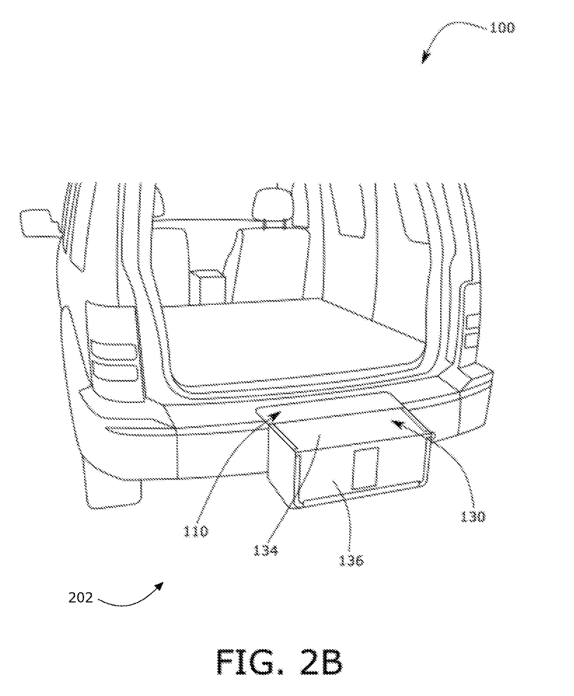

FIGS. 2A-2B show side and front perspective views of the staircase 100 of FIG. 1, according to an embodiment of the present disclosure. The first-step 120 may be attached to the attachment-mechanism 110 and may include a first L-shaped configuration 122 defined by a first stepping-section 124 and a first wall-section 126. Similarly, the second-step 130 may include a second L-shaped configuration 132 defined by a second stepping-section 134 and a second wall-section 136. As illustrated here, the first wall-section 126 and the second wall-section may be equal in height 127. Further, the first stepping-section 124 and the second stepping-section 134 may be equal in length 128 and width 129.

In one embodiment, the first stepping-section 124 and the second stepping-section 134 may include a first non-slip surface 121 and a second non-slip surface 131 thereon, respectively. In one embodiment, the first non-slip surface 121 and the second non-slip surface 131 may be constructed of rubber. The rubber may allow the pet to grip onto the first stepping-section 124 and the second stepping-section 134 to allow them to easily climb the staircase 100. Other materials are also contemplated such as silicones, textured plastics, etc.

As shown, the second wall-section 136 may be pivotally connected to the first stepping-section 124 such that the second-step 130 is configured to pivot between a folded-state 202 (FIG. 2B) and an unfolded-state 204 (FIG. 2A). In one embodiment, the second wall-section 136 may be pivotally-connected to the first stepping-section 124 via a hinge-mechanism 138. Preferably, in the folded-state 202, the second-step 130 may be stacked atop the first-step 120 in a box-like configuration to allow for compact storage on the vehicle 10.

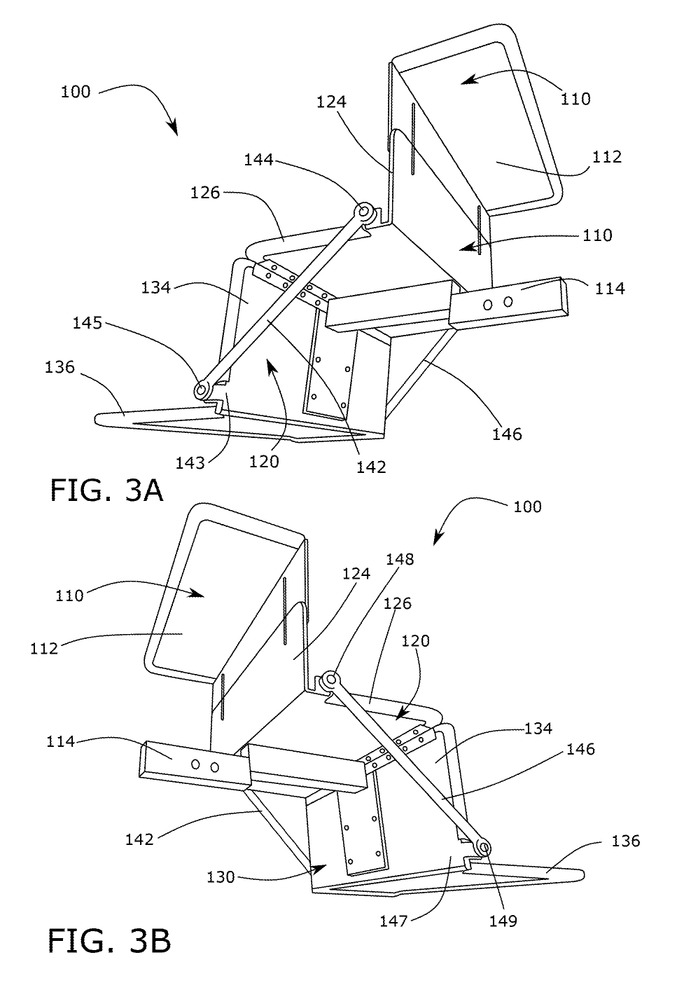

FIGS. 3A-3B show left-side and right-side perspective views looking at the bottom of the staircase 100, according to another embodiment of the present disclosure. In one embodiment, the attachment-mechanism 110 may include a first attachment-bracket 112 for mounting the staircase 100 to the vehicle 10. The first attachment-bracket 112 may be attached to the first wall-section 126 of the first-step 120. In this embodiment, the first attachment-bracket 112 may extend horizontally from the first wall-section 126 forming a lip which may be placed over the rear-surface 5 of the vehicle 10 and secured thereto.

Further, the attachment-mechanism 110 may include a second attachment-bracket 114. This second attachment-bracket 114 may be attached to the first stepping-section 124 of the first-step 120. In one embodiment, the second attachment-bracket 114 may extend horizontally from a rear-surface of the first stepping-section 124. Further, the second attachment-bracket 114 may be extendable to allow for attachment to different shapes and sizes of vehicles 10 or into a mount or hitch on the vehicle 10.

Further, as shown, a first support-rod 142 may be attached about a first-side 143 of the staircase 100. This first support-rod 142 may be attached to the first-step 120 via a first swivel-connector 144 and attached to the second-step 130 via a second swivel-connector 145. Similarly, the staircase 100 may include a second support-rod 146 attached about a second-side 147 of the staircase 100. The second support-rod 146 may be attached to the first-step 120 via a third swivel-connector 148 and attached to the second-step 130 via a fourth swivel-connector 149. The first support-rod 142 and the second support-rod 146 may be particularly useful for providing added support to the staircase 100 and the swivel-connectors may be important for preventing the first support-rod 142 and the second support-rod 146 from inhibiting folding and unfolding of the staircase 100.

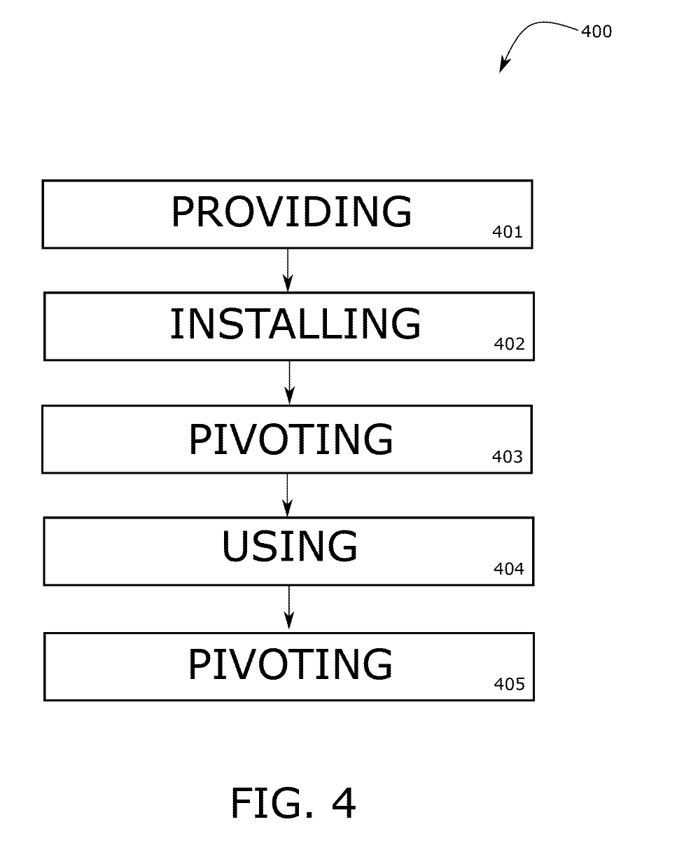

FIG. 4 is a flow diagram illustrating a method of using a staircase for installation onto a vehicle 400, according to an embodiment of the present disclosure. As illustrated, the method of using a staircase for installation onto a vehicle 400 may include the steps of: step one 401, providing the staircase 100 as above; step two 402, installing the staircase 100 onto the rear-surface 5 of the vehicle 10 via the attachment-mechanism 110; step three 403, pivoting the second-step 130 into the unfolded-state 204; step four 404, using the staircase 100 to enter a rear of the vehicle 10; and step five 405, pivoting the second-step 130 into the folded-state 202.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for staircase 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A staircase for installation onto a vehicle, the staircase comprising:
an attachment-mechanism, the attachment-mechanism configured to mount the staircase to a rear-surface of the vehicle;
a first-step attached to the attachment-mechanism, the first-step including a first L-shaped configuration defined by a first stepping-section and a first wall-section; and
a second-step including a second L-shaped configuration defined by a second stepping-section and a second wall-section, the second wall-section being pivotally-connected to the first stepping-section such that the second-step is configured to pivot between a folded-state and an unfolded-state.

2. The staircase of claim 1, wherein in the folded-state the second-step is stacked atop the first-step.

3. The staircase of claim 1, further comprising a first support-rod attached about a first-side of the staircase.

4. The staircase of claim 3, wherein the first support-rod is attached to the first-step via a first swivel-connector, and wherein the first support-rod is attached to the second-step via a second swivel-connector.

5. The staircase of claim 1, further comprising a second support-rod attached about a second-side of the staircase.

6. The staircase of claim 5, wherein the second support-rod is attached to the first-step via a third swivel-connector, and wherein the second support-rod is attached to the second-step via a fourth swivel-connector.

7. The staircase of claim 1, wherein the second wall-section is pivotally-connected to the first stepping-section via a hinge-mechanism.

8. The staircase of claim 1, wherein the attachment-mechanism includes a first attachment-bracket.

9. The staircase of claim 8, wherein the first attachment-bracket is attached to the first wall-section of the first-step.

10. The staircase of claim 1, wherein the attachment-mechanism further includes a second attachment-bracket.

11. The staircase of claim 10, wherein the second attachment-bracket is attached to the first stepping-section of the first-step.

12. The staircase of claim 1, wherein the first wall-section and the second wall-section are equal in height.

13. The staircase of claim 1, wherein the first stepping-section and the second stepping-section are equal in length.

14. The staircase of claim 1, wherein the first stepping-section and the second stepping-section are equal in width.

15. The staircase of claim 1, wherein the staircase is constructed of aluminum.

16. The staircase of claim 1, wherein the staircase is constructed of stainless steel.

17. The staircase of claim 1, wherein the first stepping-section and the second stepping-section include a first non-slip surface and a second non-slip surface, respectively.

18. The staircase of claim 17, wherein the first non-slip surface and the second non-slip surface comprise rubber.

19. A staircase for installation onto a vehicle, the staircase comprising:
a first attachment-bracket, the first attachment-bracket configured to mount the staircase to a rear-surface of the vehicle;
a first-step attached to an attachment-mechanism, the first-step including a first L-shaped configuration defined by a first stepping-section and a first wall-section; and
a second-step including a second L-shaped configuration defined by a second stepping-section and a second wall-section, the second wall-section being pivotally-connected to the first stepping-section such that the second-step is configured to pivot between a folded-state and an unfolded-state;
a first support-rod attached about a first-side of the staircase and attached to the first-step via a first swivel-connector, and wherein the first support-rod is attached to the second-step via a second swivel-connector;
a second support-rod attached about a second-side of the staircase and is attached to the first-step via a third swivel-connector, and wherein the second support-rod is attached to the second-step via a fourth swivel-connector;
wherein the folded-state includes the second-step being stacked atop the first-step;
wherein the second wall-section is pivotally-connected to the first stepping-section via a hinge-mechanism;
wherein the first attachment-bracket is attached to the first wall-section of the first-step;
wherein the first wall-section and the second wall-section are equal in height;
wherein the first stepping-section and the second stepping-section are equal in length;
wherein the first stepping-section and the second stepping-section are equal in width; and
wherein the first stepping-section and the second stepping-section include a first non-slip surface and a second non-slip surface, respectively.

20. A method of using a staircase for installation onto a vehicle, the method comprising the steps of:
providing the staircase, the staircase including:
an attachment-mechanism, the attachment-mechanism configured to mount the staircase to a rear-surface of the vehicle;
a first-step attached to the attachment-mechanism, the first-step including a first L-shaped configuration defined by a first stepping-section and a first wall-section; and
a second-step including a second L-shaped configuration defined by a second stepping-section and a second wall-section, the second wall-section being pivotally-connected to the first stepping-section such that the second-step is configured to pivot between a folded-state and an unfolded-state;
installing the staircase onto the rear-surface of the vehicle via the attachment-mechanism;
pivoting the second-step into the unfolded-state;
using the staircase to enter a rear of the vehicle; and
pivoting the second-step into the folded-state.
